(19) United States
(12) Patent Application Publication
(10) Pub. No.: US 2006/0205464 A1
(43) Pub. Date: Sep. 14, 2006

(54) Video game

(76) Inventors: William G. Bentz, Laurel, MD (US); Gonzalo F. Valdes, Tampa, FL (US)

Correspondence Address: William G. Bentz, 8106 Shannon's Alley, Laurel, MD, 20724, US

(21) Appl. No.: 11/078,664

(22) Filed: Mar. 14, 2005

(51) Int. Cl. A63F 13/00

(52) U.S. Cl. 463/4

(57) ABSTRACT

One embodiment of a method provides, through a first video game, at least one or more athletes. The method plays, through a second video game, a game with at least the one or more athletes by importing the one or more athletes from the first video game to the second video game. The first video game and the second video game are of different sports.

### FIELD OF THE INVENTION

The present invention relates in general to video games.

### DESCRIPTION OF BACKGROUND INFORMATION

The video game industry is a growing multi billion dollar industry. Electronic Arts' Madden NFL Football has been recognized as the most popular sports video game ever. Electronic Arts has compared the Madden NFL Football game to an ever-evolving novel, with a new chapter being written every year. Electronic Arts, as a leading developer and publisher of interactive entertainment software, has emphasized the need to continue to take a video game and its users to new heights. Accordingly, new ways are needed to enhance a user's game experience.

### BRIEF DESCRIPTION OF THE DRAWINGS

In the drawings, like reference numerals represent similar parts of the illustrated embodiments of the present invention throughout the several views and wherein:

FIGS. 1A and 1B depict exemplary embodiments of methods; and

FIGS. 2-4 depict exemplary embodiments of video games.

### DETAILED DESCRIPTION

A method may provide, through a first video game, one or more athletes and/or team rosters, for example, including the one or more athletes. The method may play, through a second video game, a game with at least the one or more athletes by importing the one or more athletes and/or team rosters from the first video game to the second video game. The first video game and the second video game may be of different sports. The method may allow video game companies such as, for example, Electronic Arts to integrate some and/or all of their sports games. The method may also allow gamers to try to determine (e.g., year after year) who is the best athlete and/or team in the world, for example, by playing one or more sports video games with athletes and/or teams outside their specialties.

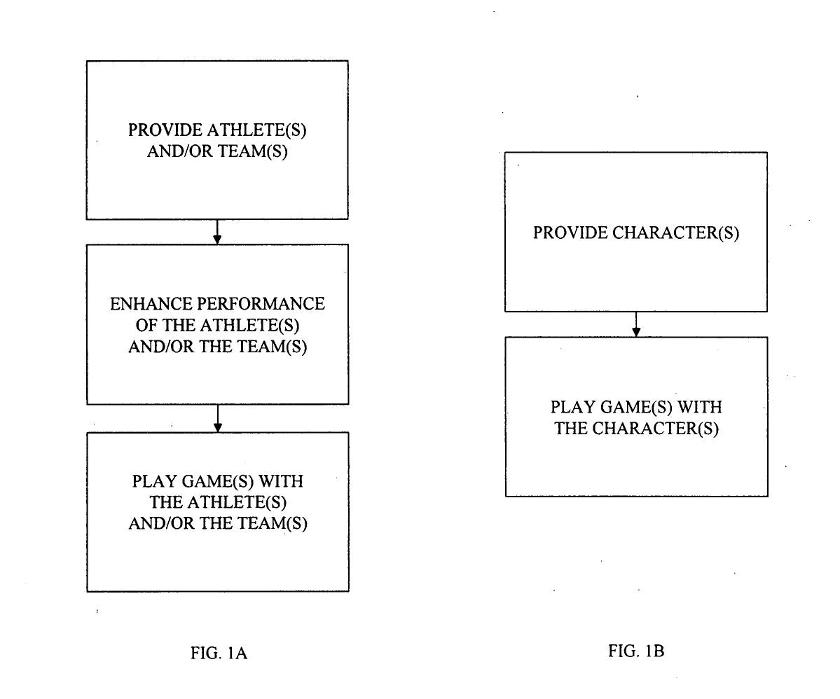

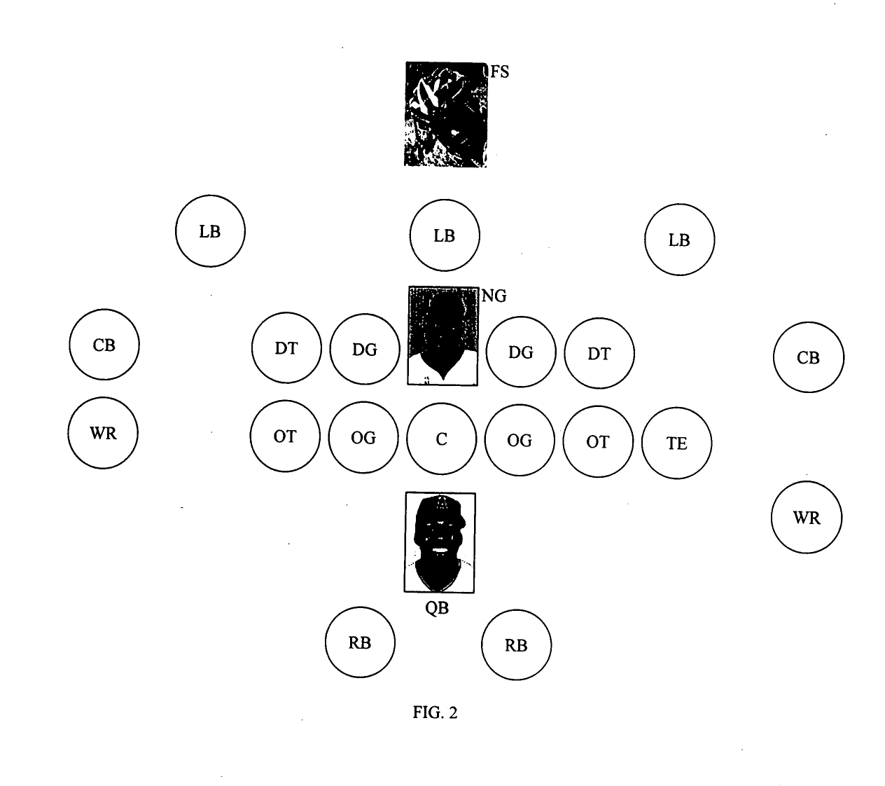

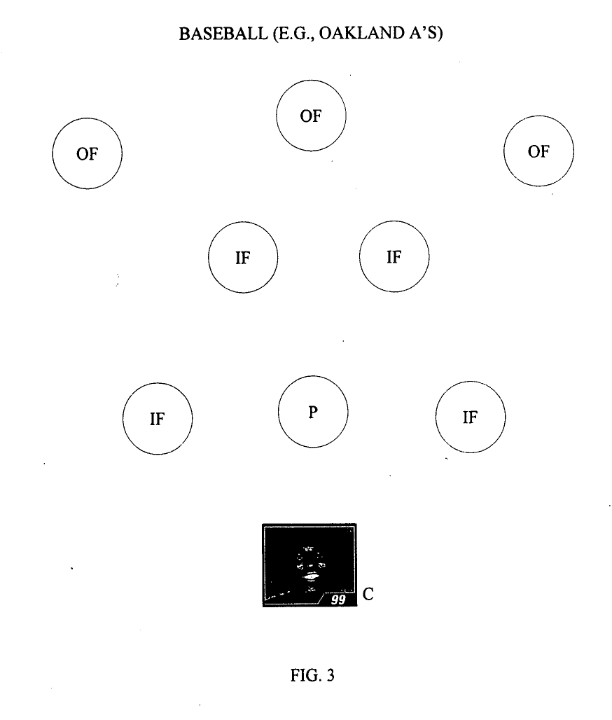

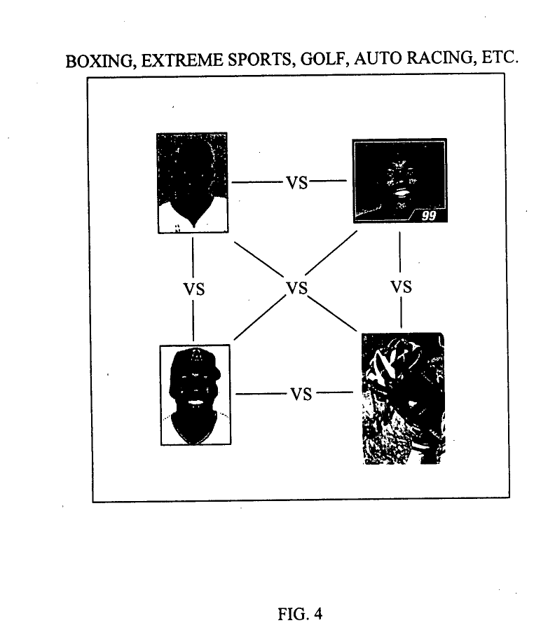

An exemplary combination (see, for example, FIGS. 1-4) may also include one or more of the following:
A method may provide, through a video game, a pool including athletes and/or teams of different sports. The method may play, through the video game, a game with at least one or more of the athletes and/or teams by at least selecting the one or more of the athletes and/or teams from the pool. Each of the teams may include a roster. The method may add, through the video game, one or more of the athletes to one or more of the team rosters. The team rosters may be associated with a first sport, and the athletes may be associated with a second sport. The game may be the first sport or the second sport;
A method may provide, through a first video game, at least a first team roster and, through a second video game, at least a second team roster. The method may play, through the second video game, a game with at least the first team roster and/or the second team roster by importing the first team roster from the first video game to the second video game. The first video game and the second video game may be of different sports and/or leagues. One of the first team roster and the second team roster, for example, may a team of a professional sports league (e.g., NFL Football, NBA Basketball, etc.), and the other one of the first team roster and the second team roster may be a team of an amateur sports league (e.g., NCAA Football, NBA Basketball);
A method may provide, through a first video game, at least one or more pro athletes and, through a second video game, at least one or more amateur athletes. The method may play the second video game with at least the one or more pro athletes and/or the one or more amateur athletes by importing the one or more pro athletes from the first video game to the second video game. The first video game may be professional football and the second video game may be college football. The first video game may also be professional basketball and the second video game may also be college basketball;
A method may provide, through a video game, a pool including pro athletes. The method may add, through the video game, one or more of the pro athletes to one or more college teams, for example, by using the pool. The method may play, through the video game, a game by using the one or more college teams;
A method may provide, through a first video game, at least one or more first characters and, through a second video game, at least one or more second characters. The method may play a third video game with at least one of (i) the one or more first characters and (ii) the one or more second characters by importing (i) the one or more first characters from the first video game to the third video game and (ii) the one or more second characters from the second video game to the third game. The first video game, the second video game and/or the third video game may be different games. The first, second and/or third video games may be categorized as sports, adventure, and/or action. The one or more first characters and/or second characters may include one or more superheroes, action figures, and/or athletes. A first sports team roster may be made up of the one or more first characters and/or other characters, and a second sports team roster may be made up of the one or more second characters and/or other characters; and/or
A method may provide, through a first video game, at least one or more characters. The method may play a second video game with at least the one or more characters by importing the one or more characters from the first video game to the second video game. The first video game and the second video game may be of different categories. The categories may include sports, adventure, and/or action. The one or more characters may include one or more superheroes, action figures, and/or athletes. The one or more characters may include, for example, Psymon (of SSX Tricky), Nick Kang (of True Crime), Raiden (of Mortal Kombat) and/or SpongeBob (of SpongeBob).

The video game such as, for example, the first video game may be one of: football, basketball, baseball, boxing, wrestling, martial arts, skateboarding, surfing, rock climbing, skiing, ski jumping, bobsledding, luge, extreme sports, water sports, soccer, hockey, rugby, cricket, lacrosse, volleyball, tennis, golf, auto racing, motor sports, track and field, gymnastics, water polo, swimming, speed skating, ice skating, roller skating, diving, rowing, archery, kayak, olympic sports, table tennis, cycling, weight-lifting, water skiing, fishing, shooting, bowling, horse racing, billiards, rodeo, cheerleading and/or poker, and the second video game may be a different one. The first and/or second video games may be any other known game.

The pool (e.g., a list, a group, etc.) may include athletes and/or rosters associated with football, basketball, baseball, boxing, wrestling, martial arts, skateboarding, surfing, rock climbing, skiing, ski jumping, bobsledding, luge, extreme sports, water sports, soccer, hockey, rugby, cricket, lacrosse, volleyball, tennis, golf, auto racing, motor sports, track and field, gymnastics, water polo, swimming, speed skating, ice skating, roller skating, diving, rowing, archery, kayak, olympic sports, table tennis, cycling, weight-lifting, water skiing, bowling, horse racing and/or rodeo. The pool, for example, may include (i) a plurality of active NFL All-Pro players, (ii) a plurality of active NBA All-Star players and/or (iii) a plurality of active MLB All-Star players. The pool may also include (i) a plurality of retired NFL All-Pro players, (ii) a plurality of retired NBA All-Star players and/or (iii) a plurality of retired MLB All-Star players. The pool may further include some and/or all NFL, NBA, MLB, PGA, NHL, MLS, and/or NASCAR players (e.g., active and/or retired) and/or rosters.

The one or more athletes and/or team rosters may be selected from the pool, for example, by (i) scrolling through the pool, (ii) highlighting the one or more athletes and/or teams and (iii) pressing a button of a controller. The one or more athletes, for example, may be selected from the pool to be added to a roster. Also, the one or more athletes and/or team rosters from the first video game may be imported, through a memory card, to the second video game, for example, as it is known to import an entire draft class from Electronic Arts' NCAA Football to Madden NFL Football via a memory card. The method may provide a draft for the one or more athletes. The method may also allow roster moves such as, for example, trade players, sign players, and/or release players to be made to strengthen a lineup. Injuries and/or demands by the one or more athletes from one sport (e.g., the first video game) may be carried forward to another sport (e.g., the second video game).

The one or more athletes may include professional, amateur and/or fictional athletes, which may be active and/or retired. The one or more athletes may also be single-sport or multi-sport athletes. The one or more team rosters may be associated with (e.g., be a part of) professional, amateur and/or fictional sports leagues such as, for example, NFL, NBA, MLB, NHL, MLS and/or NCAA. The one or more athletes and/or team rosters may include Lou Gehrig, Gordie Howe, Michael Jordan, Jackie Robinson, Rafer Johnson, Wilt Chamberlain, Bo Jackson, Dave Winfield, Jim Thorpe, Jim Brown, Muhammad Ali, Pele, Lance Armstrong, Andre Agassi, Randy Johnson, Shaquille O'Neal, Vladimir Guerrero, LeBron James, Warren Sapp, Andy Roddick, David Beckham, Tracy McGrady, Michael Vick, Kevin Garnett, Kobe Bryant, Tim Montgomery, Simeon Rice, Ray Lewis, Tony Gonzalez, Peter Forsberg, Tiger Woods, Artus Taymazov, Michael Phelps, Kelly Slater, Freddy Adu, Jonny Wilkinson, Paul Hamm, Thierry Henry, Allen Iverson, Terrell Owens, Jason Kidd, Brian Urlacher, Alex Rodriguez, Ichiro Suzuki, Sergei Fedorov, Barry Bonds, Roger Federer, Zinedine Zidane, Tim DeBoom, Jeremy Bloom, Roy Jones Jr., Peter Reid and/or Tom Pappas.

A performance of the one or more athletes and/or team rosters may be enhanced to play a game by putting the one or more athletes and/or team rosters through one or more drills and/or pre-season games. The drills may include performing certain plays, runs, and/or passes, and may be part of a training camp.

The video game(s) may be playable by consumers on platforms including personal computers and/or entertainment systems (e.g., consoles and/or handhelds) such as, for example, Sony PlayStation2, Sony PlayStation, Microsoft Xbox, Nintendo GameCube and/or Game Boy Advance. The platforms may also include online, over the Internet and/or other online networks.

A machine-readable medium having encoded information, which when read and executed by a machine causes, for example, a method (e.g., one or more described embodiments). The machine-readable medium may store programmable parameters and may also store information including executable instructions, non-programmable parameters, and/or other data. The machine-readable medium may comprise read-only memory (ROM), random-access memory (RAM), nonvolatile memory, an optical disk, a magnetic tape, and/or magnetic disk. The machine-readable medium may further include, for example, a carrier wave modulated, or otherwise manipulated, to convey instructions that can be read, demodulated/decoded and executed by the machine (e.g., one or more of the platforms). The machine may comprise one or more microprocessors, microcontrollers, and/or other arrays of logic elements.

In view of the foregoing, it will be apparent to one of ordinary skill in the art that the described embodiments may be implemented in software, firmware, and/or hardware. The actual software code or specialized control hardware used to implement the described embodiments is not limiting of the invention. Thus, the operation and behavior of the embodiments is described without specific reference to the actual software code or specialized hardware components. The absence of such specific references is feasible because it is clearly understood that artisans of ordinary skill would be able to design software and/or control hardware to implement the embodiments based on the description herein.

The foregoing presentation of the described embodiments is provided to enable any person skilled in the art to make or use the present invention. Various modifications to these embodiments are possible, and the generic principles presented herein may be applied to other embodiments as well. As such, the present invention is not intended to be limited to the embodiments shown above, any particular sequence of acts, and/or any particular configuration of hardware but rather is to be accorded the widest scope consistent with the principles and features disclosed in any fashion herein.

What is claimed is:

1. A method comprising:
providing, through a first video game, one or more athletes; and
playing, through a second video game, a game with the one or more athletes by importing the one or more athletes from the first video game to the second video game,
wherein the first video game and the second video game are of different sports.

2. The method of claim 1, wherein the one or more athletes includes star athletes.

3. The method of claim 2, wherein the one or more athletes includes at least one of (i) an active athlete and (ii) a retired athlete.

4. The method of claim 1, wherein the one or more athletes includes fictional athletes.

5. The method of claim 1, wherein the one or more athletes includes professional athletes.

6. The method of claim 1, wherein the second video game is one of (i) football, (ii) baseball, (iii) basketball, (iv) boxing, (v) golf, (vi) hockey, (vii) auto racing, (viii) soccer, (ix) rugby, (x) tennis, (xi) volleyball, (xii) extreme sports and (xiii) wrestling.

7. The method of claim 1,
wherein the first video game is one of (i) football, (ii) baseball, (iii) basketball, and (iv) boxing, and
wherein the second video game is a different one of (i) football, (ii) baseball, (iii) basketball, and (iv) boxing.

8. The method of claim 1, further comprising
enhancing performance of the one or more athletes to play the game by putting the one or more athletes through one or more drills.

9. The method of claim 1, wherein the one or more athletes from the first video game is imported, through a memory card, to the second video game.

10. A method comprising:
providing, through a video game, a plurality of athletes of different sports; and
playing, through the video game, a game with one or more of the athletes by at least selecting the one or more of the athletes.

11. The method of claim 10, wherein the plurality of athletes include (i) a plurality of active NFL All-Pro players, (ii) a plurality of active NBA All-Star players and (iii) a plurality of active MLB All-Star players.

12. The method of claim 11, wherein the game is one of (i) football, (ii) basketball and (iii) baseball.

13. The method of claim 12, wherein the plurality of athletes also include (i) a plurality of retired NFL All-Pro players, (ii) a plurality of retired NBA All-Star players and (iii) a plurality of retired MLB All-Star players.

14. The method of claim 10, wherein the plurality of athletes include every active NFL, NBA and MLB player.

15. The method of claim 10, further comprising
enhancing performance of the one or more of the athletes to play the game by putting the one or more of the athletes through one or more drills.

16. A method comprising:
providing, through a video game, a plurality of teams of different sports; and
playing, through the video game, a game with one or more rosters of one or more of the teams by at least selecting the one or more of the teams.

17. The method of claim 16, wherein the plurality of teams include one or more NFL, NBA and MLB teams.

18. The method of claim 17, wherein the game is one of (i) football, (ii) basketball and (iii) baseball.

19. The method of claim 16, wherein the plurality of teams include every NFL, NBA and MLB team.

20. A method comprising:
providing, through a first video game, one or more pro athletes and, through a second video game, one or more amateur athletes; and
playing the second video game with the one or more pro athletes and the one or more amateur athletes by importing the one or more pro athletes from the first video game to the second video game.

21. The method of claim 20, wherein the first video game is professional football and the second video game is college football.

22. The method of claim 20, wherein the first video game is professional basketball and the second video game is college basketball.

23. The method of claim 20, wherein the one or more pro athletes from the first video game is imported, through a memory card, to the second video game.

24. A method comprising:
providing, through a video game, a plurality of pro athletes and a plurality of college teams;
adding, through the video game, one or more of the pro athletes to one or more of the college teams; and
playing, through the video game, a game with the one or more college teams.

25. The method of claim 24, wherein the plurality of pro athletes include at least one of (i) a plurality of NFL players and (ii) a plurality of NBA players.

26. The method of claim 25, wherein the game is one of (i) football and (ii) basketball.

27. The method of claim 24, wherein the plurality of pro athletes include every active NFL player.

28. The method of claim 24, wherein the plurality of pro athletes include every active NBA player.

29. A method comprising:
providing, through a first video game, one or more first characters and, through a second video game, one or more second characters; and
playing a third video game with at least one of (i) the one or more first characters and (ii) the one or more second characters by importing (i) the one or more first characters from the first video game to the third video game and (ii) the one or more second characters from the second video game to the third game,
wherein the first video game, the second video game and the third video game are different games.

30. The method of claim 29, wherein one or more of the first, second and third video games is categorized as sports.

31. The method of claim 29, wherein one or more of the first, second and third video games is categorized as adventure.

32. The method of claim 29, wherein one or more of the first, second and third video games is categorized as action.

33. The method of claim 29,
wherein a first sports team roster is made up of the one or more first characters, and a second sports team roster is made up of the one or more second characters, and
wherein the third video game is played with the first sports team roster and the second sports team roster.

34. A method comprising:
providing, through a first video game, one or more characters; and
playing a second video game with the one or more characters by importing the one or more characters from the first video game to the second video game,
wherein the first video game and the second video game are of different categories.

35. A method comprising:
providing, through a first video game, a team roster including athletes; and
playing, through a second video game, a game with one or more of the athletes by importing the team roster from the first video game to the second video game.

36. The method of claim 35, wherein the first video game and the second video game are of different sports.

37. The method of claim 35, wherein the team roster is part of a professional sports league.

38. The method of claim 35, wherein the team roster is part of an amateur sports league.

39. A method comprising:
providing, through a first video game, a first team roster and, through a second video game, a second team roster; and
playing, through a second video game, a game with the first team roster and the second team roster by importing the first team roster from the first video game to the second video game.

40. The method of claim 39, wherein the first video game and the second video game are of different sports.

41. The method of claim 39, wherein the first team roster is part of a professional sports league, and the second team roster is part of an amateur sports league.

42. A method comprising:
providing, through a video game, a single-sport pro athlete of a first sport and a roster of a pro team of a second sport;
adding, through the video game, the athlete to the roster of the team; and
playing, through the video game, a game by using the team,
wherein the first sport and the second sport are different sports.
